(19) United States
(12) Patent Application Publication
(10) Pub. No.: US 2004/0227313 A1
(43) Pub. Date: Nov. 18, 2004

(54) Multi-function mechanic's creeper with reversible head section

(76) Inventor: Troy Shockley, Greenville, SC (US)

Correspondence Address: MCNAIR LAW FIRM, PA, P.O. BOX 10827, GREENVILLE, SC, 29603-0827, US

(21) Appl. No.: 10/439,850

(22) Filed: May 16, 2003

(51) Int. Cl. B25H 5/00

(52) U.S. Cl. 280/32.6

(57) ABSTRACT

A muti-function mechanic's creeper having a plurality of functional positions. The creeper includes a frame assembly having a base, middle, and head sections pivotally connected. Interlinking connectors are carried by the frame assembly for connecting the base, middle, and head sections to configure the creeper between different functional positions including a flat creeper position, an intermediate inclined headrest position, and a folded position. A rotatable frame assembly is rotatably carried by the head section on which a head cushion is affixed. The head cushion may be rotated to opposite sides of the head section depending on the creeper's configuration to provide either a headrest, a bare utility shelf for carrying items, or a cushioned seat on which the mechanic can sit.

### FIELD OF THE INVENTION

The present invention relates to a mechanic's creeper, and more particularly to a mechanic's creeper that can be transformed between different functional positions to provide added utility to a single piece of equipment.

### BACKGROUND OF THE INVENTION

During the performance of maintenance on automobiles and the like, it is often required that a mechanic be able to work under the chassis of the automobile. In the past, it has been known to use flat surfaces on wheels, commonly known as creepers, enabling the mechanic to lie on supine position and survey and work underneath the automobile. Additionally, it is known to use work bays where cars may be placed on hydraulic lifts and elevated to a raised position sufficient to allow the mechanic to stand under the car and perform maintain. Furthermore, it is known that mechanics sometimes use small seats with rollers to sit next to an automobile and move easily when working around the automobile exterior.

The problem that has arose is that to work on an automobile, the mechanic uses a creeper for work underneath an automobile chassis, and a mobile seat for work around the automobile exterior. The use of two separate work platforms instead of one is an added expense to the mechanic. When considering that many automotive shops work on several cars at the same time, the redundancy in work platforms greatly increases the cost necessary to work on the automobiles. Furthermore, the work area around the automobile quickly becomes congested considering that numerous tools are typically being used to diagnose and correct problems; such as computer aided diagnostic stations, hand held tools, along with replacement parts and other like items lying around the work area. Accordingly, depending on the work activity, either the seat or the creeper is not being utilized and merely takes up space around the work area, further congesting the work area and making it more difficult to maintain an orderly work place by the mechanic.

As a result, transformable mechanic's creepers have recently become popular. Typically, the transformable mechanic's creepers fold between a flat creeper position and a seat position so that the need to have two different pieces of equipment is eliminated. That is, instead of having a separate mechanic's seat and a separate flat creeper, the two pieces of equipment may be built into one and simply transformed to the desired piece of equipment as needed. This eliminates both the expense of two pieces of equipment and the space required to store two pieces of equipment.

For example, U.S. Pat. No. RE35,732 discloses a transformable mechanic's creeper, commonly referred to as a “Z creeper”, which converts between a flat creeper position and a folded seat position. U.S. Pat. No. 6,199,877 B1 discloses another form of the “Z creeper” which includes two sections which are disposed in a horizontal plane in a flat creeper position. In the seat position, one of the sections is elevated above the other by means of pivoting linkages. In this embodiment, a slide roller assembly is extended from the base to support the second section in the flat creeper position. In the seat position, the slide roller assembly may be used as a support for a tool tray and the like.

U.S. Pat. No. RE37,372E discloses another type of transformable mechanic's creeper, commonly referred to as a “centerfold” creeper. In the centerfold creeper, there are two end sections and a center section. In the creeper position, the center section is disposed between the end sections, all lying in a horizontal plane to provide a flat creeper. In the seat position, the end sections slide together to raise the center section above the end sections by linkage arrangement.

Yet another type of transformable mechanic's creeper is illustrated in U.S. Pat. No. 6,095,532 wherein a transformable creeper is provided having three sections that form a flat creeper and then fold into a seat position. In this embodiment an intermediate position is provided wherein a head section of the creeper is tilted to hold the mechanic's head or back in an inclined position. However, in this type of creeper, there is no cushion in the seat position for the mechanic to sit upon unless the cushion from the head section is removed and placed on the other side of the opposite side of the creeper frame. Since the cushion disclosed in the patent is removable, it can be easily misplaced or slide off of the frame section even though the patent illustrates the loose cushion being tethered to the frame. Should the tether become unfastened or break then there is nothing holding the cushion on the frame section and the mechanic may possibly slip off of the creeper when moving around, or knock the cushion out of position.

Accordingly, it is an object of the present invention to provided an improved transformable mechanic's creeper that transforms between a plurality of positions, which include at least a flat creeper position for working under a car and a folded creeper position providing a mobile seat or utility shelf for working around the car.

It is an object of the present invention to provide an improved transformable mechanic's creeper that includes a reversibly mounted cushion for switching between a seat cushion or headrest cushion and a utility shelf.

It is an object of the present invention to provided a transformable mechanic's creeper that transforms between a plurality of functional positions, wherein the creeper cushions are securely affixed to the creeper to prevent accidental detachment or shifting when being moved between reversible positions.

### SUMMARY OF THE INVENTION

The above objectives are accomplished according to the present invention by providing a transformable mechanic's creeper having a plurality of functional positions between which the creeper may be folded depending on a desired use by the mechanic that includes a frame assembly having a base section, a middle section and a head section pivotally interconnected. A base cushion is carried by the base section, a middle cushion is carried by the middle section, and a head cushion is carried by the head section.

Interlinking connectors are carried by the frame assembly for interconnecting certain ones of the base section, middle section and head section to configure the creeper between the plurality of functional positions. A flat creeper position is included in the functional positions wherein the base cushion, the middle cushion, and the head cushion lie generally in a common plane to provide a flat creeper platform. An intermediate position is included in the functional positions wherein the base cushion and the middle cushion lie generally in a common plane, while the head cushion is inclined to provide a headrest for supporting the head or back of a mechanic in an elevated condition. Also, a folded position is included in the functional positions wherein the head section is folded to at least partially overlie the base section in a vertically aligned and spaced arrangement so that the head cushion and the base cushion are facing each other.

A rotatable frame assembly is rotatably carried by the head section, and the head cushion is affixed to the rotatably frame assembly so that the head cushion may be rotated to opposite sides of the head section. The rotatable frame assembly has a utility position wherein the head cushion is aligned facing the base cushion when the creeper is in the folded position to provide a utility shelf for carrying items. The rotatable frame assembly also has a seat position wherein the head cushion is positioned on the opposite side of the head section from the utility position so that the head cushion provides a seat when the creeper is in the folded position. The rotatable frame assembly includes a frame lock for locking the rotatable frame assembly to the head section to restrain the rotatable frame assembly from moving between the utility position and the seat position.

Advantageously, the head section includes a head frame, and the rotatable frame assembly is rotatably carried by the head frame. Preferably, the head frame includes a first frame leg and a second frame leg in a laterally spaced arrangement. In the preferred embodiment, the rotatable frame assembly includes a first L-shaped bracket pivotally connected to the first frame leg, and a second L-shaped bracket pivotally connected to the second frame leg. At least one cross brace is interconnecting the first and second L-shaped brackets for carrying the head cushion in a rotating manner to allow the head cushion to rotate between the utility position and the seat position. The first and second L-shaped brackets include a pivot flange pivotally connected to the first and second frame legs respectively, and a brace flange extending perpendicular to the pivot flange for carrying the cross brace to interconnect the first and second L-shaped brackets so that when the rotatable frame assembly is moved to the utility position, the L-shaped brackets carry the utility shelf in a recessed arrangement between the first and second frame legs, which act as walls to prevent items from sliding off the utility shelf.

Advantageously, the head cushion is carried on a top side of the rotatable frame assembly and the utility shelf is carried on a bottom side of the rotatable frame assembly so that when the rotatable frame assembly is in the utility position and the creeper is configured in the folded position, the utility shelf faces up to provide a support for a tool tray and the like, and when the rotatable frame assembly is in the seat position and the creeper is configured in the folded position, the head cushion faces up to provide a seat on which the mechanic may rest.

At least one connector retention element is carried by the frame assembly for retaining the interlinking connectors in the desired functional position. In the preferred embodiment, the interlinking connectors include at least one primary interlinking connector having a first end pivotally connected to the base section and a second end pivotally connected to the head section which extends and retracts in a telescoping manner to configure the creeper. A first connector retention element is carried by the primary interlinking connector for engaging the head section to restrain the primary interlinking connector to maintain the creeper in the flat position and the intermediate position, respectively.

At least one secondary interlinking connector is also included having a first end pivotally connected to the base section and a second end pivotally connected to the middle section, which extends and retracts in a telescoping manner to configure the creeper. A second connector retention element is carried by the base section for engaging the secondary interlinking connector to restrain the secondary interlinking connector to maintain the creeper in the flat position and the folded position, respectively.

A plurality of casters are carried by the base section and the middle section for providing the frame assembly with mobility in any of the functional positions.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a perspective view of a transformable mechanic's creeper in a flat position according to the invention;

FIG. 2 is a perspective view of a transformable mechanic's creeper in an intermediated position according to the invention;

FIG. 2a is a side elevation view of a transformable mechanic's creeper in an intermediated position showing rotation of the head cushion carried by the rotatable frame assembly according to the invention;

FIG. 3 is a perspective view of a transformable mechanic's creeper in a folded position providing a utility shelf according to the invention;

FIG. 4 is a perspective view of a transformable mechanic's creeper in a folded position providing a cushioned seat according to the invention;

FIG. 5 is a perspective view of an alternative embodiment of a transformable mechanic's creeper in a folded position providing a utility shelf according to the invention;

FIG. 6 is a perspective view of an alternative embodiment of a transformable mechanic's creeper in a folded position providing a cushioned seat according to the invention;

FIG. 7 is a perspective view of an alternative embodiment of a transformable mechanic's creeper in a folded position providing a utility shelf according to the invention; and,

FIG. 8 is a perspective view of an alternative embodiment of a transformable mechanic's creeper in a folded position providing a cushioned seat according to the invention.

### DETAILED DESCRIPTION OF A PREFERRED EMBODIMENT

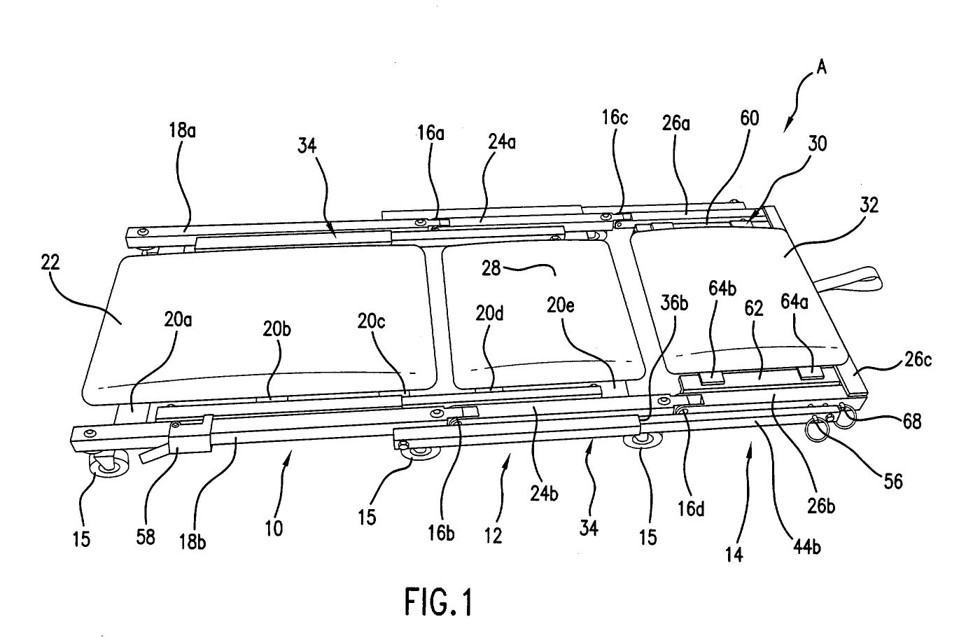

With reference to the drawings, the invention will now be described in more detail. Referring to FIG. 1, a transformable mechanic's creeper, designated generally as A, is illustrated which may be folded between a plurality of functional positions depending on a desired use by the mechanic when working on an automobile or the like. The creeper is comprised of a generally rectangular shaped frame assembly having a base section designated generally as 10, a middle section designated generally as 12, and a head section designated generally as 14. Middle section 12 is pivotally connected to base section 10 at pivot points 16a and 16b. Head section 14 is pivotally connected to middle section 12 at pivot point 16c and 16d. A plurality of casters 15 are carried by the base section and middle section for providing the frame assembly with mobility in any of the functional positions. In this construction and arrangement, the frame sections can be folded to a plurality of functional positions as is described herein below.

Base section 10 includes a base frame carrying a base cushion 22. The base frame includes a first base frame leg 18a and a second base frame leg 18b in a laterally spaced arrangement. A plurality of cross braces 20a, 20b, and 20c interconnect base section frame legs 18a and 18b. Base cushion 22 is carried by cross braces 20a-c for supporting a mechanic when working on the creeper.

Middle section 12 includes a middle frame carrying a middle cushion 28. The middle frame includes a first middle frame leg 24a and a second middle frame leg 24b in a laterally spaced arrangement and interconnected by cross braces 20d and 20e. Middle cushion 28 is carried by cross braces 20d and 20e to support a mechanic when working on the creeper.

Head section 14 includes a head frame carrying a rotatable frame assembly, designated generally as 30. The head frame includes a first head frame leg 26a and a second head frame leg 26b in a laterally spaced arrangement interconnected by third frame leg 26c at the distal ends of frame legs 26a and 26b opposite pivot points 16c and 16d. Rotatable frame assembly 30 is disposed between head section frame legs 26a and 26b. A head cushion 32 is affixed to frame assembly 30 to support a mechanic when working on the creeper. As described in detail below, rotatable frame assembly 30 is pivotally connected to head section frame legs 26a and 26b to rotate head cushion 32 between functional positions.

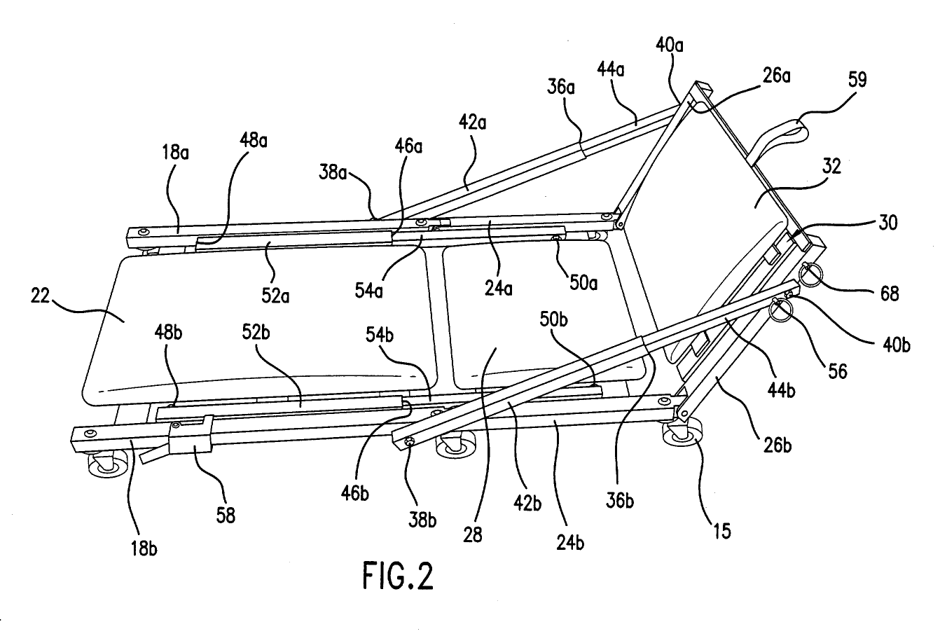

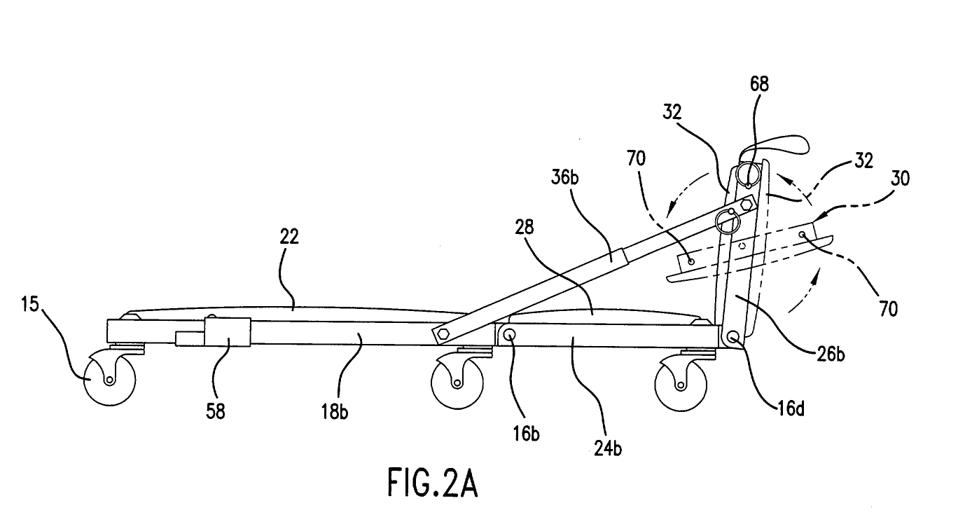

Linkage means, designated generally as 34, are carried by the frame assembly sections for interconnecting certain ones of said base section, middle section and head section to configure and maintain the creeper in a plurality of functional positions. Referring to FIG. 2, the linkage means preferably includes a plurality of interlinking connectors that connect the base section to both the middle section and head section. A pair of primary interlinking connectors 36a and 36b have first ends 38a and 38b pivotally connected to base section frame legs 18a and 18b, and second ends 40a and 40b pivotally connected to head section frame legs 26a and 26b, respectively. The primary interlinking connectors include first leg portions 42a and 42b which receives second leg portions 44a and 44b, respectively, in a telescoping arrangement that allows interlinking connectors to extend and retract according to a desired functional position.

A pair of secondary interlinking connectors 46a and 46b include first ends 48a and 48b pivotally connected to base section frame legs 18a and 18b, and second ends 50a and 50b pivotally connected to middle section frame legs 24a and 24b, respectively. As with the primary interlinking connectors, the secondary interlinking connectors also include first leg portions 52a and 52b, and second leg portions 54a and 54b that combine in a telescoping arrangement to extend and retract to configure the creeper in a desired functional position.

As can best be seen in FIG. 1, the functional positions for the creeper include a flat position wherein base cushion 22, middle cushion 28, and head cushion 32 lie generally in a common plane to provide a flat creeper platform on which a mechanic can work. The primary and secondary Interlinking connectors thus have a first pivot position in which base section 10, middle section 12, and head section 14 are maintained in a common plane to configure the creeper in the flat position. In the flat position, both the primary and secondary interlinking connectors are fully extended.

As can best be seen in FIG. 2, the creeper includes an intermediate position wherein base cushion 22 and middle cushion 28 lie generally in a common plane, while head cushion 32 is inclined to provide a headrest for supporting the mechanic's head or back in an elevated condition. Often, when a mechanic is working underneath an automobile, he must raise his head to view the area he is working on. When working for extended periods, repeated raising of the head can become a difficult task, especially to hold the head in the raised position when laying flat. Moving the head section to the orientation of FIG. 2 provides the support needed to maintain the head in a raised position for working. The primary and secondary interlinking connectors thus have a second pivot position in which base section 10 and middle section 12 are maintained in a common plane, and the head section 14 is maintained in an inclined orientation to the base section and middle section to configure the creeper in the intermediate position. As best shown in FIG. 2, to incline head section 14, the head section is pivoted upwards to partially retract primary interlinking connectors 36a and 36b, while secondary interlinking connectors 46a and 46b remain fully extended to maintain base section 10 and middle section 12 in a common plane.

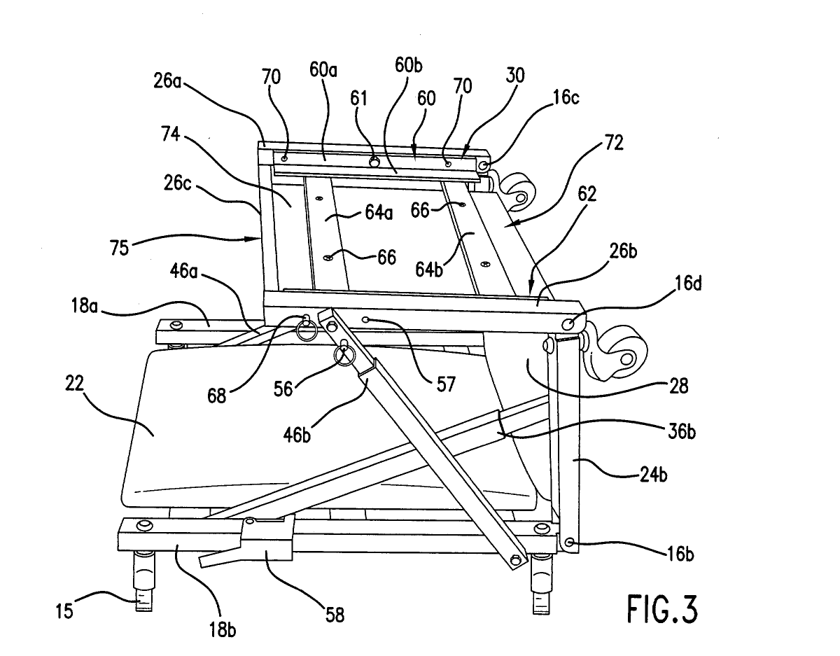

As best shown in FIG. 3, the creeper also includes a folded position wherein head section 14 is folded to at least partially overlie base section 10 in a vertically aligned and spaced arrangement. The primary and secondary interlinking connectors thus have a third pivot position in which the head section is maintained in the vertically spaced orientation above the base section to configure the creeper in the folded position. As shown in FIG. 3, both the primary and secondary interlinking connectors are retracted to allow the middle section and head section to pivot upwards and overtop base section 10, respectively.

Advantageously, the creeper includes connector retention elements for retaining the primary and secondary interlinking connectors in the first, second, and third pivot positions in order to maintain the creeper in one of the functional position.

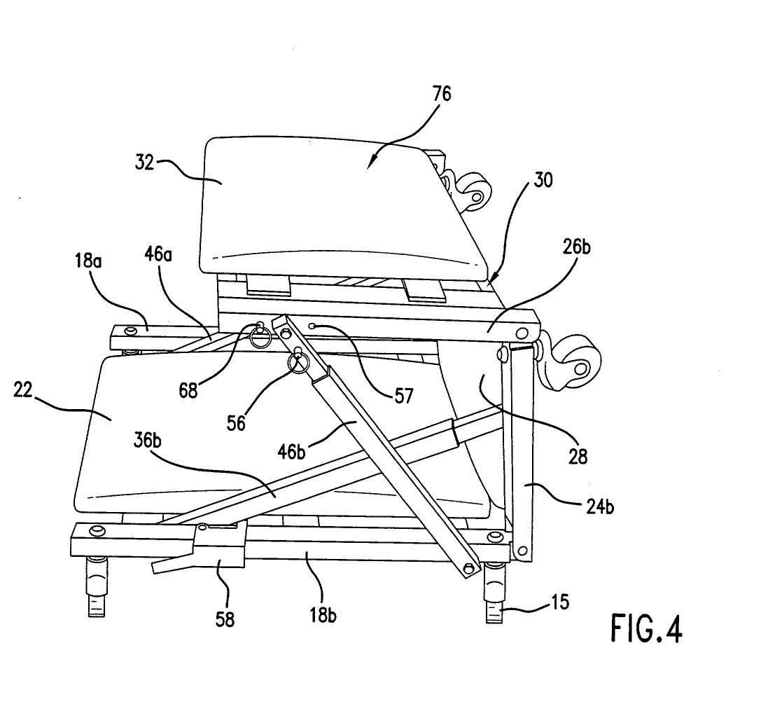

Referring to FIG. 1, in the preferred embodiment, a first connector retention element 56 is carried by second portion 44b of primary interlinking connector 36b. First connector retention element 56 engages frame leg 26b of head section 14 to restrain the primary interlinking connector in an extended condition to maintain the creeper in the flat position. Preferably, the first connector retention element is a spring biased releasable pin extending form the primary interlinking connector to engage a slot 57 (best seen in FIG. 4) in the side of frame leg 26b. When the pin is directed into the slot by way of the spring bias, the primary interlinking connector is locked together with the frame leg in an extended position to prevent the head section from pivoting.

Referring to FIG. 2, in order to pivot head section 14 to an inclined orientation, first connector retention element 56 must be disengaged by retracting the pin from slot 57 in frame leg 26b. Once moved to the inclined orientation by pulling up on strap 59, head section 14 is held in place by the pin re-engaging the frame leg. First connector retention element 56 re-engaged frame leg 26b in the by resting on a top side of the frame leg when the creeper is configured in the intermediate position. This prevents the head section from pivoting downward to the flat position of FIG. 1. Because the primary interlinking connector can no longer extend with the pin wedged against the frame leg, the creeper is accordingly maintained in the intermediate position.

The creeper also includes a second connector retention element 58 for engaging secondary interlinking connector 46b to restrain the secondary interlinking connector to maintain the creeper in the flat position, together with first connector retention element 56. In a preferred embodiment, second connector retention element 58 is a spring biased bracket carried by frame leg 18b of base section 10. The bracket slides around frame leg 18b and extends overtop of secondary interlinking connector 46b to prevent it from pivoting and changing the creepers configuration. When secondary interlinking connector 46b can no longer pivot when blocked by the bracket, middle section 12 is prevent from moving and is accordingly maintained in its flat functional position. The spring biased of the bracket keeps it in position over secondary interlinking connector 46b when the creeper is configured in the flat position. When the bracket is retracted, the middle section and head section can be configured in the folded position, assuming first connector retention element 56 is also disengaged from slot 57.

Referring to FIG. 3, once in the folded position, bracket 58 slides underneath secondary interlinking connector 46b, which has pivoted upward and retracted to position middle section 12 in a generally upright orientation. In this arrangement, secondary interlinking connector 46b is prevent from pivoting downward to the flat position of the creeper since the bracket blocks the path of the secondary interlinking connector. Accordingly, because secondary interlinking connector 46b can no longer pivot, it cannot extend to allow middle section 12 to pivot back to the flat position, and the creeper is maintained in the folded position as illustrated in FIGS. 3 and 4.

As can best be seen in FIG. 2a, the creeper advantageously includes a rotatable frame assembly 30 rotatably carried by head section 14. Head cushion 32 is affixed to the rotatable frame assembly so that the head cushion is reversible to be rotated to opposite sides of the head section frame to provide different functional positions for the creeper. Referring to FIGS. 1 and 3, in the preferred embodiment, the rotatable frame assembly includes a first bracket 60 rotatably connected by bolt 61 to frame leg 26a of head section 14. A second bracket 62 is rotatably connected in the same manner to frame leg 26b opposite first bracket 60. First and second L-shaped brackets 60 and 62 are interconnected by cross braces 64a and 64b. Head cushion 32 is affixed to cross braces 64a and 64b with screws 66. In the preferred embodiment, the first and second brackets are L-shaped include a pivot flange 60a pivotally connected to frame legs 26a and 26b, and a brace flange 60b extending perpendicular to the pivot flange for carrying cross braces 64a and 64b to interconnect the first and second L-shaped brackets. In this construction and arrangement, the head cushion is firmly attached to the rotatable frame assembly so that it cannot become removed when rotating, and cannot become detached or shift positions during use.

To prevent the rotatable frame assembly from rotating, a frame lock 68 is carried by head section 14 for locking the rotatable frame assembly in position. In the preferred embodiment, the frame lock is a spring biased pin carried by frame leg 26b which engages a pinhole 70 (FIG. 2a) in L-shaped bracket 62. Each end of the L-shaped bracket includes a pinhole to engage spring biased pin 68 and lock the rotatable frame assembly between opposite sides of the head section, as best shown in FIG. 2a.

The rotatable frame assembly thus includes a top side carrying head cushion 32 and an opposite bottom side without a cushion which comprises a bare utility shelf. As best shown in FIG. 3, rotatable frame assembly 30 has a utility position, designated generally as 72, wherein the head cushion is rotated and locked in a position aligned facing the base cushion when the creeper is in the folded position. In the preferred embodiment, the bottom side of head cushion 32 is a reinforced metal or plastic surface which acts as a utility shelf 74 for holding items such as a tool box and the like. Alternatively, however, the bottom side of rotatable frame assembly 30 providing utility shelf 74 may be constructed and arranged to include a variety of molded trays, organizers, and the like commonly known to those skilled in the art, being affixed to cross braces 64a and 64b on the opposite side of head cushion 32 for organizing and holding tools and other work implements. In a further advantageous embodiment, a second head cushion may also be attached to the bottom side which is of a different size or type than head cushion 32 carried on the top side of the rotatable frame assembly.

Advantageously, when the L-shaped brackets of rotatable frame assembly 30 are rotated into the utility position of FIG. 3, the brackets provide a slightly recessed area, designated generally as 75, where the frame legs and brackets provide walls that help prevent items from sliding or rolling off of the utility shelf when moving the creeper.

As best shown in FIG. 4, the rotatable frame also has a seat position, designated generally as 76, wherein the head cushion is rotated and positioned on the opposite side of the head section when moved from the utility position so that the head cushion provides a cushioned seat when the creeper is in the folded position. Preferably, L-shaped bracket 60 and L-shaped bracket 62 extend to rest on head section frame leg 26c when in the seat position to help support and maintain the head cushion in the seat position when weight is applied to the creeper.

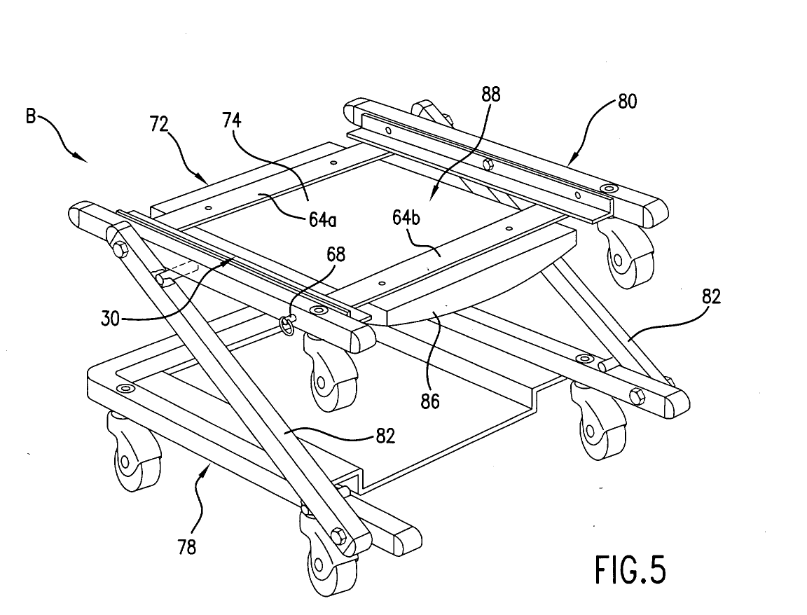

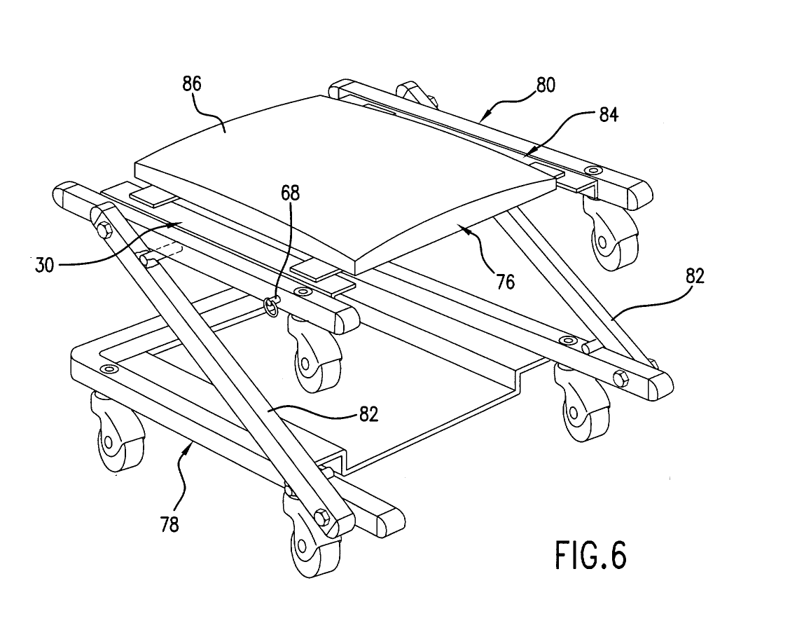

Referring to FIG. 5, an alternative embodiment of a transformable mechanic's creeper, designated generally as B, is shown. The creeper of FIG. 5, commonly known as the “Z” type creeper, as described in the background of the invention, has a base section, designated generally as 78, and a head section, designated generally as 80. The base and head sections are pivotally interconnected by linkage means 82 for configuring the creeper between a typical flat creeper position in which the base section and head section are in a common plane, and a folded position as shown in FIG. 5, in which head section 80 is at least partially overlying base section 78 in a vertically aligned and spaced arrangement. Advantageously, creeper B is constructed and arranged to incorporate rotatable frame assembly 30 in head section 80 as described above. Accordingly, referring to FIGS. 5 and 6, rotatable frame assembly 30 includes a top side, designated generally as 84, carrying a cushion 86, and an opposite bottom side, designated generally as 88, without a cushion comprising a bare utility shelf 74. As best shown in FIG. 5, rotatable frame assembly 30 has a utility position, designated generally as 72, wherein cushion 86 is rotated and locked in a position aligned facing base section 78 when the creeper is in the folded position. As described above, the bottom side of the cushion acts as a utility shelf 74 for holding items such as a tool box and the like. Alternatively, the bottom side of rotatable frame assembly 30 providing utility shelf 74 may be constructed and arranged to include a variety of molded trays, organizers, and the like commonly known to those skilled in the art, being affixed to cross braces 64a and 64b on the opposite side of cushion 86 for organizing and holding tools and other work implements. In a further advantageous aspect, a second cushion may also be attached to bottom side 88, which is of a different size or type than cushion 86 carried on topside 84 of the rotatable frame assembly.

As best shown in FIG. 6, rotatable frame assembly 30 also has a seat position, designated generally as 76, wherein cushion 86 is rotated and positioned on the opposite side of the head section when moved from utility position 72 so that cushion 86 provides a cushioned seat when the creeper is in the folded position. To prevent the rotatable frame assembly from rotating, frame lock 68, as described above, is also included and carried by head section 80 for locking the rotatable frame assembly in either the seat position or utility position.

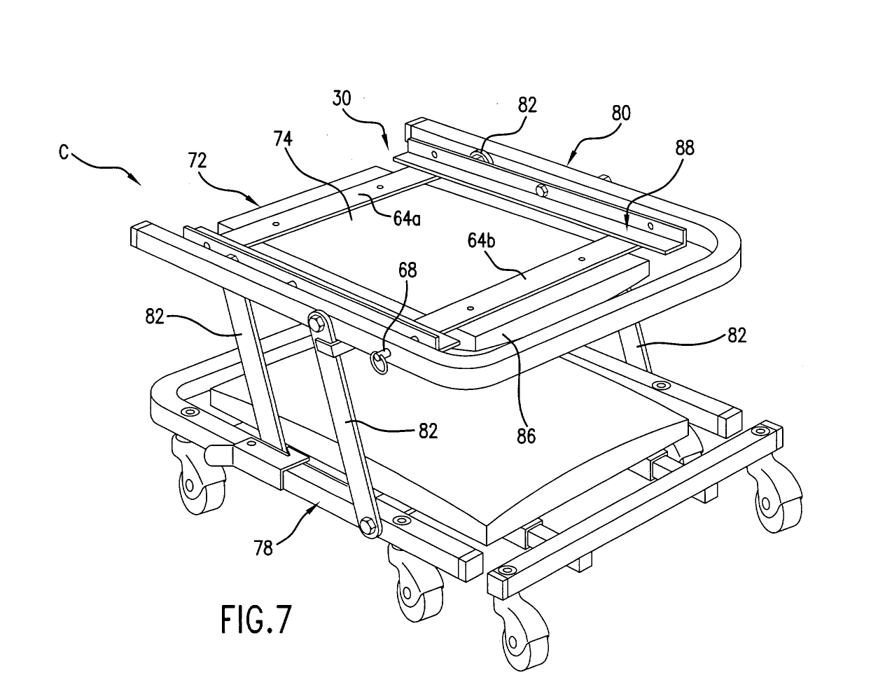

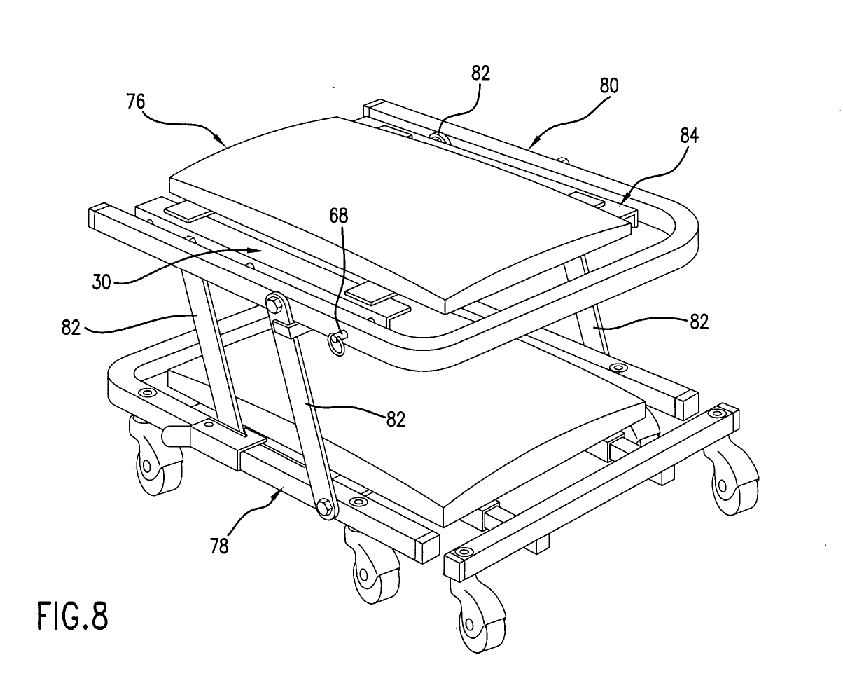

Referring to FIG. 7, a further alternative embodiment of a transformable mechanic's creeper, designated generally as C, is shown. The creeper of FIG. 7, is a variation of the “Z” type creeper shown in FIGS. 5 and 6. Again, the creeper includes a base section, designated generally as 78, and a head section, designated generally as 80. The base and head sections are pivotally interconnected by linkage means 82 for configuring the creeper between a typical flat creeper position in which the base section and head section are in a common plane, and a folded position as shown in FIGS. 7 and 8, in which head section 80 is at least partially overlying base section 78 in a vertically aligned and spaced arrangement. Advantageously, creeper C is constructed and arranged to incorporate rotatable frame assembly 30 in head section 80 as described above. Accordingly, referring to FIGS. 7 and 8, rotatable frame assembly 30 includes a top side, designated generally as 84, carrying a cushion 86, and an opposite bottom side, designated generally as 88, without a cushion comprising a bare utility shelf 74. As best shown in FIG. 7, rotatable frame assembly 30 has a utility position, designated generally as 72, wherein cushion 86 is rotated and locked in a position aligned facing base section 78 when the creeper is in the folded position. As described above, the bottom side of the cushion acts as a utility shelf 74 for holding items such as a toolbox and the like. Alternatively, the bottom side of rotatable frame assembly 30 providing utility shelf 74 may be constructed and arranged to include a variety of molded trays, organizers, and the like commonly known to those skilled in the art, being affixed to cross braces 64a and 64b on the opposite side of cushion 86 for organizing and holding tools and other work implements. In a further advantageous embodiment, a second cushion may also be attached to bottom side 88, which is of a different size or type than cushion 86 carried on topside 84 of the rotatable frame assembly.

As best shown in FIG. 8, rotatable frame assembly 30 also has a seat position, designated generally as 76, wherein cushion 86 is rotated and positioned on the opposite side of the head section when moved from utility position 72 so that cushion 86 provides a cushioned seat when the creeper is in the folded position. To prevent the rotatable frame assembly from rotating, frame lock 68, as described above, is also included and carried by head section 80 for locking the rotatable frame assembly in either the seat position or utility position.

While a preferred embodiment of the invention has been described using specific terms, such description is for illustrative purposes only, and it is to be understood that changes and variations may be made without departing from the spirit or scope of the following claims.

What is claimed is:

1. A transformable mechanic's creeper having a plurality of functional positions between which the creeper may be folded depending on a desired use by the mechanic, said creeper comprising:
a frame assembly having a base section, a middle section and a head section pivotally interconnected;
a base cushion carried by said base section;
a middle cushion carried by said middle section;
a head cushion carried by said head section;
interlinking connectors carried by said frame assembly for interconnecting certain ones of said base section, middle section and head section to configure said creeper between said plurality of functional positions;
a flat position included in said functional positions wherein said base cushion, said middle cushion, and said head cushion lie generally in a common plane to provide a flat creeper platform;
an intermediate position included in said functional positions wherein said base cushion and said middle cushion lie generally in a common plane, while said head cushion is inclined to provide a headrest for supporting the head or back of a mechanic in an elevated condition;
a folded position included in said functional positions wherein said head section is folded to at least partially overlie said base section in a vertically aligned and spaced arrangement so that said head cushion and said base cushion are facing each other;
a rotatable frame assembly included in said head section on which said head cushion is carried for rotating said head cushion between opposite sides of said head section; and
said rotatable frame assembly having a utility position wherein said head cushion is aligned facing said base cushion when the creeper is in said folded position to provide a utility shelf for carrying items, and said rotatable frame assembly having a seat position rotated from said utility position wherein said head cushion is positioned on the opposite side of said head section from said utility position so that said head cushion provides a seat cushion in said folded position.

2. The creeper of claim 1 wherein said head section includes a head frame; said rotatable frame assembly being carried by said head frame; and said head frame having a first frame leg and a second frame leg in a laterally spaced arrangement pivotally connected to said rotatable frame assembly.

3. The creeper of claim 2 wherein said rotatable frame assembly includes a first bracket pivotally connected to said first frame leg, and a second bracket pivotally connected to said second frame leg; and at least one cross brace interconnecting said first and second brackets; and said head cushion being affixed to one side of said rotatable frame assembly to allow said head cushion to rotate between said utility position and said seat position.

4. The creeper of claim 3 wherein said first and second brackets include first and second L-shaped brackets; said L-shaped brackets including a pivot flange pivotally connected to said first and second frame legs, and a brace flange extending perpendicular to said pivot flange for carrying said cross brace to interconnect said first and second L-shaped brackets so that when said rotatable frame assembly is rotated to said utility position, said L-shaped brackets and said cross brace form said utility shelf between said first and second frame legs with said utility shelf being recessed between said frame legs which act as walls to prevent items from sliding off said utility shelf.

5. The creeper of claim 1 wherein said head cushion is carried on a top side of said rotatable frame assembly and said utility shelf is carried on a bottom side of said rotatable frame assembly so that when said rotatable frame assembly is in said utility position and said creeper is configured in said folded position, said utility shelf faces up without the head cushion to provide a support for a tool tray and the like, and when said rotatable frame assembly rotated to said seat position, said head cushion faces up to provide said seat cushion on which the mechanic may sit.

6. The creeper of claim 1 including a frame lock for locking said rotatable frame assembly to said head section in either one of said utility position and said seat position to prevent said rotatable frame assembly form rotating.

7. The creeper of claim 1 including at least one connector retention element carried by said frame assembly for retaining said interlinking connectors in the desired functional position.

8. The creeper of claim 1 wherein said interlinking connectors include at least one primary interlinking connector having a first end pivotally connected to said base section and a second end pivotally connected to said head section which extends and retracts in a telescoping manner to configure said creeper.

9. The creeper of claim 8 including a first connector retention element carried by said primary interlinking connector; said first connector retention element engaging said head section to restrain said primary interlinking connector to maintain said creeper in said flat position and said intermediate position, respectively.

10. The creeper of claim 9 including at least one secondary interlinking connector having a first end pivotally connected to said base section and a second end pivotally connected to said middle section which extends and retracts in a telescoping manner to configure said creeper.

11. The creeper of claim 10 including a second connector retention element carried by said base section; said second connector retention element engaging said secondary interlinking connector to restrain said secondary interlinking connector to maintain said creeper in said flat position and said folded position, respectively.

12. The creeper of claim 1 including a plurality of casters carried by said base section, and a plurality of casters carried by said middle section for providing said frame assembly with mobility in any of said functional positions.

13. A transformable mechanic's creeper having a plurality of functional positions between which the creeper may be folded depending on a desired use by the mechanic, said creeper comprising:
a frame assembly having at least a base section and a head section pivotally interconnected;
a plurality of interlinking connectors connecting said base section and said head section to configure said head section between a flat position and a folded position; and
a rotatable frame assembly rotatably carried in said head section having a top side and an opposite bottom side being reversible through rotation of said rotatable frame assembly;
a cushion affixed to said top side of said rotatable frame assembly;
a utility shelf provided by the bottom side of said cushion; and
said rotatable frame assembly and said cushion having functional rotated positions that include a cushioned headrest, a cushioned seat, or a utility shelf depending on the selected configuration of the creeper and the rotatable frame assembly.

14. The creeper of claim 13 wherein said head cushion is carried on said top side of said rotatable frame assembly and said utility shelf is provided on said bottom side of said rotatable frame assembly; said rotatable frame assembly having a seat position and utility position so that when said rotatable frame assembly is in said utility position and said creeper is configured in said folded position, said utility shelf faces up to provide a support for a tool tray and the like, and when said rotatable frame assembly is in said seat position and said creeper is configured in said folded position, said head cushion faces up to provide a seat on which the mechanic may sit.

15. The creeper of claim 13 wherein said head section includes a head frame; said rotatable frame assembly being carried by said head frame; and said head frame having a first frame leg and a second frame leg in a laterally spaced arrangement pivotally connected to said rotatable frame assembly.

16. The creeper of claim 15 wherein said rotatable frame assembly includes a first bracket pivotally connected to said first frame leg, and a second bracket pivotally connected to said second frame leg; and at least one cross brace interconnecting said first and second brackets; and said head cushion being affixed to one side of said cross brace to allow said head cushion to rotate between a utility position and a seat position.

17. The creeper of claim 16 wherein said first and second brackets include first and second L-shaped brackets; said L-shaped brackets including a pivot flange pivotally connected to said first and second frame legs, and a brace flange extending perpendicular to said pivot flange for carrying said cross brace to interconnect said first and second L-shaped brackets so that when said rotatable frame assembly is rotated to said utility position, said L-shaped brackets and said cross brace form said utility shelf between said first and second frame legs with said utility shelf being recessed between said frame legs which act as walls to prevent items from sliding off said utility shelf.

18. The creeper of claim 17 wherein said rotatable frame assembly includes a frame lock for interlocking said rotatable frame assembly to said head section to lock said rotatable frame against rotation in either one of said utility position and said seat position.

19. The creeper of claim 13 including at least one connector retention element carried by said frame assembly for retaining said interlinking connectors to hold said creeper in said flat position or said folded position.

20. A transformable mechanic's creeper having a plurality of functional positions between which the creeper may be folded depending on a desired use by the mechanic, said creeper comprising:
a frame assembly having a base section, a middle section, and a head section pivotally connected to allow said creeper to be folded between said plurality of functional positions;
linkage means interconnecting certain ones of said base, middle and head sections for configuring the creeper between a flat position in which said base cushion, middle cushion, and head cushion lie generally in a common; an intermediate position in which said base and middle cushions lie generally in a common plane, and said head cushion is inclined; and a folded position in which said head section at least partially overlies said base section with said head cushion facing said base cushion;
said base section including a base frame having a first base frame leg and a second base frame leg laterally spaced and interconnected by a cross brace for carrying a base cushion;
said middle section including a middle frame having a first middle frame leg and a second middle frame leg laterally spaced and interconnected by a cross brace for carrying a middle cushion;
said head section including a head frame having a first head frame leg and a second head frame leg laterally spaced and interconnected by a third frame leg;
a rotatable frame assembly pivotally carried by said head section between said first head frame leg and said second head frame leg;
a cushion affixed to said rotatable frame assembly so that said head cushion may be rotated between opposite sides of said head section; and
said rotatable frame assembly having a utility position wherein said head cushion is aligned facing said base cushion when the creeper is in said folded position to provide a utility shelf for carrying items, and said rotatable frame having a seat position wherein said head cushion is positioned on the opposite side of said head section from said utility position so that said head cushion provides a seat when the creeper is in said folded position.

21. The creeper of claim 20 including at least one connector retention element carried by said frame assembly for retaining said linkage means in the desired functional position.

22. The creeper of claim 20 wherein said linkage means includes a primary interlinking connector having a first end pivotally connected to said base section and a second end pivotally connected to said head section which extends and retracts in a telescoping manner to configure said head section in a selected functional position.

23. The creeper of claim 21 wherein said linkage means includes a secondary interlinking connector having a first end pivotally connected to said base section and a second end pivotally connected to said middle section which extends and retracts in a telescoping manner to configure said middle section in a selected functional position.

24. The creeper of claim 20 wherein said head cushion is carried on a top side of said rotatable frame assembly and said utility shelf is carried on a bottom side of said rotatable frame assembly so that when said rotatable frame assembly is in said utility position and said creeper is configured in said folded position, said utility shelf faces up to provide a support for a tool tray and the like, and when said rotatable frame assembly is in said seat position and said creeper is configured in said folded position, said head cushion faces up to provide a seat on which the mechanic may rest.

25. The creeper of claim 20 wherein said rotatable frame assembly includes a frame lock for interlocking said rotatable frame assembly to said head section to restrain said rotatable frame assembly from moving between said utility position and said seat position.
